(19) United States
(12) Patent Application Publication
(10) Pub. No.: US 2020/0302558 A1
(43) Pub. Date: Sep. 24, 2020

(54) GAS METER ENERGY-SAVING PROMPTING METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua SHAO, Chengdu (CN)

(21) Appl. No.: 16/359,959

(22) Filed: Mar. 20, 2019

(51) Int. Cl. G06Q 50/06; G06Q 30/02; G05F 1/66; G06F 17/11

(52) U.S. Cl. CPC G06Q 50/06; G06Q 30/0226; G06F 17/11; G05F 1/66; G06Q 30/0234

(57) ABSTRACT

The present invention provides a gas meter energy-saving prompting method based on a compound Internet of Things (IoT) and an IoT system, and relates to the field of IoT. The gas meter energy-saving prompting method based on the compound IoT and the IoT system use each management sub-platform to generate a gas using change waveform according to the current month gas count data and the gas history count data, and determine whether the current month gas count data is greater than the preset first threshold and whether the current slope of the gas using change waveform is greater than the preset second threshold; if so, generate an energy-saving prompt. If the current month gas count data is greater than the preset first threshold, it indicates that the user has used gas excessively in the current month. If the slope is small, it indicates that the increase of the gas usage of the user has slowed down or has fallen, the user has a sense of saving, and it is not needed to send an energy-saving prompt temporarily. If the slope is large, it indicates that the increase of the gas usage of the user is fast, an energy-saving prompt needs to be sent, which conforms to the actual situation of the user and sends energy-saving prompts for users who truly do not have environmental awareness.

### TECHNICAL FIELD

The present invention relates to the field of the Internet of Things (IoT), and in particular to a gas meter energy-saving prompting method based on a compound IoT and an IoT system.

### BACKGROUND

Natural gas is one of safe gases, and it contains no carbon monoxide and is lighter than the air. Once it leaks, it will diffuse upwards immediately and will not accumulate to form explosive gas. Its safety is relatively higher than that of other gases. The use of natural gas as energy can reduce the use of coal and oil, thus significantly improving environmental pollution; natural gas, as a clean energy, can reduce nearly 100% of sulfur dioxide and dust emission, 60% of carbon dioxide emissions and 50% of nitrogen oxides emissions, and contribute to reducing acid rain formation, alleviating the greenhouse effects of the earth, so as to fundamentally improve environmental quality. With the development of society, the use of natural gas needs to be saved because of the increasing number of people who use natural gas and the fact that natural gas is a non-renewable resource. In the prior art, the main way to save natural gas is to regionally stop the supply of gas at cities or residence communities, and there is not yet a mature technical limitation or prompt to households over-consuming gas of the energy-saving needs.

### SUMMARY

In view of this, an objective of the present invention is to provide a gas meter energy-saving prompting method based on a compound IoT and an IoT system.

According to a first aspect, the present invention provides a gas meter energy-saving prompting method based on a compound IoT, being applied to a gas meter energy-saving prompting IoT system based on a compound IoT; the gas meter energy-saving prompting IoT system based on the compound IoT comprises a plurality of user sub-platforms, a service platform, a plurality of management sub-platforms, a sensor network sub-platform, and a plurality of object sub-platforms; each of the object sub-platforms comprises a gas meter;

the plurality of gas meters send the current month gas count data and the gas history count data to the corresponding management sub-platform via a sensor network sub-platform according to their own IDs;

each of the management sub-platforms generates a gas using change waveform based on the current month gas count data and the gas history count data;

each of the management sub-platforms determines whether the current month gas count data is greater than the preset first threshold and whether the current slope of the gas using change waveform is greater than the preset second threshold;

if the current month gas count data is greater than the preset first threshold and the current slope of the gas using change waveform is greater than the preset second threshold, the management sub-platform generates an energy-saving prompt;

the management sub-platform sends the energy-saving prompt and ID associated with the energy-saving prompt to the service platform; and

the service platform sends the energy-saving prompt to the corresponding user sub-platform according to the ID associated with the energy-saving prompt.

According to a second aspect, the present invention also provides a gas meter energy-saving prompting IoT system based on a compound IoT; the gas meter energy-saving prompting IoT system based on the compound IoT comprises a plurality of user sub-platforms, a service platform, a plurality of management sub-platforms, a sensor network sub-platform, and a plurality of object sub-platforms; each of the object sub-platforms comprises a gas meter; and the gas meter energy-saving prompting IoT system based on the compound IoT comprises:

the plurality of gas meters are configured to send the current month gas count data and the gas history count data to the corresponding management sub-platform via a sensor network sub-platform according to their own IDs;

each of the management sub-platforms is configured to generate a gas using change waveform based on the current month gas count data and the gas history count data;

each of the management sub-platforms is further configured to determine whether the current month gas count data is greater than the preset first threshold and whether the current slope of the gas using change waveform is greater than the preset second threshold;

the management sub-platform is further configured to generate an energy-saving prompt if the current month gas count data is greater than the preset first threshold and the current slope of the gas using change waveform is greater than the preset second threshold;

the management sub-platform is further configured to send the energy-saving prompt and the ID associated with the energy-saving prompt to the service platform; and

the service platform is configured to send the energy-saving prompt to the corresponding user sub-platform according to the ID associated with the energy-saving prompt.

Compared with the prior art, the gas meter energy-saving prompting method based on the compound IoT and the IoT system provided by the present invention use each management sub-platform to generate a gas using change waveform according to the current month gas count data and the gas history count data, and determine whether the current month gas count data is greater than the preset first threshold and whether the current slope of the gas using change waveform is greater than the preset second threshold; if so, generate an energy-saving prompt. If the current month gas count data is greater than the preset first threshold, it indicates that the user has used gas excessively in the current month. If the slope is small, it indicates that the increase of the gas usage of the user has slowed down or has fallen, the user has a sense of saving, and it is not needed to send an energy-saving prompt temporarily. If the slope is large, it indicates that the increase of the gas usage of the user is fast, an energy-saving prompt needs to be sent, which conforms to the actual situation of the user and sends energy-saving prompts for users who truly do not have environmental awareness.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates an interactive schematic diagram of a gas meter energy-saving prompting IoT system based on a compound IoT; and

FIG. 2 and FIG. 3 illustrate flowcharts of a gas meter energy-saving prompting method based on a compound IoT.

Numerals in the drawings: 100—object sub-platform; 200—sensor network sub-platform; 300—management sub-platform; 400—service platform; 500—user sub-platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

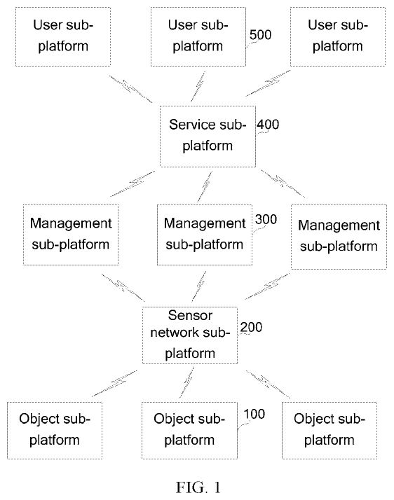

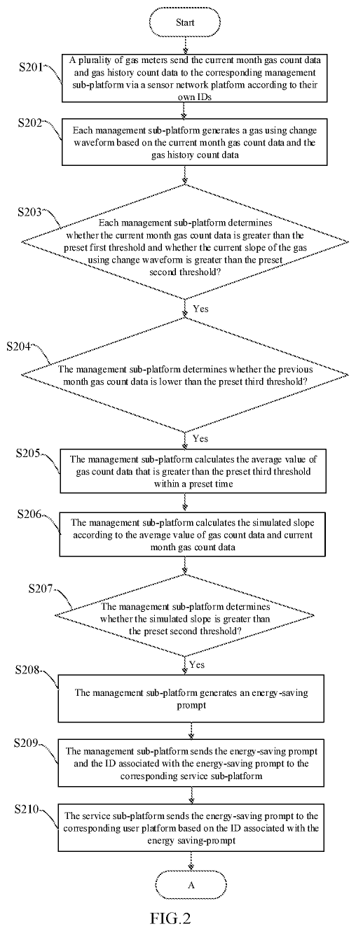

Referring to FIG. 1 and FIG. 2, an embodiment of the present invention provides a gas meter energy-saving promoting method based on a compound IoT, which is applied to a gas meter energy-saving promoting IoT system based on a compound IoT. The gas meter energy-saving prompting IoT system based on the compound IoT includes a plurality of user sub-platform 500, a service platform 400, a plurality of management sub-platform 300, a sensor network sub-platform 200, and a plurality of object sub-platform 100. Any one of the plurality of object sub-platforms 100 may be communicatively connected with the management sub-platform 300 via the sensor network sub-platform to send the data of the object sub-platform 100 to the management sub-platform 300, or receive the signal sent by the management sub-platform 300. The management sub-platform 300 is communicatively connected with the service platform 400. In this embodiment, the service platform 400 may include at least one of a gas company service platform 400, a government service platform 400 or a social operator service platform 400. The service platform 400 is communicatively connected with the user sub-platforms 500, and is configured to receive information sent by the user sub-platforms 500 and forward the information to the management sub-platform 300, as well as push information sent by the management sub-platform 300 to the user sub-platforms 500. The management sub-platform 300 and service platform 400 each may be a server. Each object sub-platform 100 includes a gas meter, and the gas meter energy-saving promoting method based on the compound IoT includes:

Step S201: A plurality of gas meters send the current month gas count data and the gas history count data to the corresponding management sub-platform 300 via a sensor network sub-platform 200 according to their own IDs.

In this embodiment, the sensor network sub-platform 200 may be a gateway, and each object sub-platform 100 may send information to the management sub-platform 300 via the gateway. The management sub-platform 300 communicates with the gas meter via the sensor network sub-platform to receive operation state information in real time. Herein, the operation state information can be sent once every 1 min, 5 min or 10 min in real time, and preferably once every 1 min to the management sub-platform 300.

Step S202: Each management sub-platform 300 generates a gas using change waveform based on the current month gas count data and the gas history count data.

The gas using change waveform reflects the fluctuation of gas history count data of the user.

Step S203: Each management sub-platform 300 determines whether the current month gas count data is greater than the preset first threshold and whether the current slope of the gas using change waveform is greater than the preset second threshold, and if so, Step S204 is executed.

If the current month gas count data is greater than the preset first threshold, it indicates that the user has used gas excessively in the current month. If the slope is small, it indicates that the increase of the gas usage of the user has slowed down or has fallen, and the user has a sense of saving, and it is not needed to send an energy-saving prompt temporarily. If the slope is large, it indicates that the increase of the gas usage of the user is fast, and an energy-saving prompt may need to be sent.

Herein, the management sub-platform 300 automatically adjusts the preset first threshold based on different seasons. For example, in winter and summer, the demands of users for gas are high, and the first threshold can be adjusted automatically to a relatively high value. In spring and autumn, the demands of users for gas are low, and the first threshold can be adjusted automatically to a relatively low value.

In addition, considering that the user may travel for one month without using gas and then return to home to start using gas, the gas used in the previous month is 0, and the gas used in the following month is high, which may cause the slope to be large. Therefore, if the gas used in the previous month is too small (even 0), the gas data in a non-normal gas using month should be removed to eliminate the error. Therefore, the gas meter energy-saving prompting method based on the compound IoT may also include the following steps:

Step S204: The management sub-platform 300 determines whether the previous month gas count data is lower than the preset third threshold, and if so, Step S205 is executed.

Step S205: The management sub-platform 300 calculates the average value of gas count data that is greater than the preset third threshold within a preset time.

Herein, the third threshold is used as the judgment criterion that the user is traveling out or away from home in the month with less gas usage amount. When the previous month gas count data is lower than the preset third threshold, it indicates that the gas usage is abnormal in the previous month, and should be removed, that is, only the average value of the gas count data within the preset time (for example, in the first half of the year) that is greater than the preset third threshold is calculated.

Step S206: The management sub-platform 300 calculates the simulated slope according to the average value of gas count data and the current month gas count data.

Step S207: The management sub-platform 300 determines whether the simulated slope is greater than the preset second threshold, and if so, Step S208 is executed.

Step S208: The management sub-platform 300 generates an energy-saving prompt.

Herein, the energy-saving prompt can be “please pay attention to saving gas”.

Step S209: The management sub-platform 300 sends the energy-saving prompt and the ID associated with the energy-saving prompt to the service platform 400.

Step S210: The service platform 400 sends the energy-saving prompt to the corresponding user sub-platform 500 according to the ID associated with the energy-saving prompt.

In this embodiment, each of the user sub-platforms 500 may be a universal electronic device, such as a Personal Computer (PC), smartphone, tablet computer, Personal Digital Assistant (PDA), and Mobile Internet Device (MID). A user can look up the fault type and solution of the gas meter at the user sub-platform 500, and completes corresponding repair processing independently.

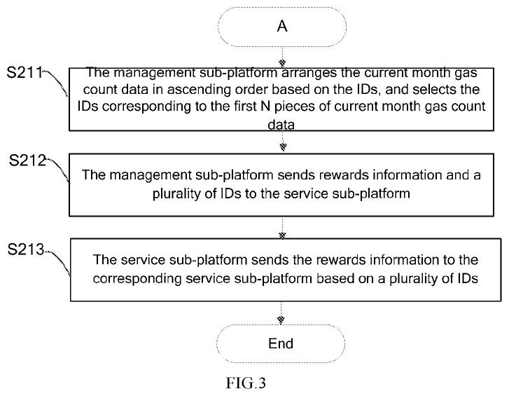

In addition, as shown in FIG. 3, in order to give incentives and rewards to gas-saving users, the gas meter energy-saving prompting method based on the compound IoT may also include the following steps:

Step S211: The management sub-platform 300 arranges the current month gas count data in ascending order based on the IDs, and selects the IDs corresponding to the first N pieces of current month gas count data.

Step S212: The management sub-platform 300 sends the rewards information and a plurality of IDs to the service platform 400.

Step S213: The service platform 400 separately sends the rewards information to the service platform 400 based on a plurality of IDs.

Herein, the rewards information may be, but not limited to an electricity purchase coupon or an electricity purchase discount coupon or environment-friendly user credits.

Referring to FIG. 1, an embodiment of the present invention further provides a gas meter energy-saving prompting IoT system based on a compound IoT. It is to be noted that for the gas meter energy-saving prompting IoT system based on the compound IoT provided by this embodiment of the present invention, the basic principles and technical effects are the same as those of the above embodiment. For brief description, parts not mentioned in this embodiment of the present invention may be referred to corresponding contents in the above embodiment. The gas meter energy-saving prompting IoT system based on the compound IoT includes a plurality of user sub-platforms 500, a service platform 400, a plurality of management sub-platforms 300, a sensor network sub-platform and a plurality of object sub-platforms 100; each of the object sub-platforms 100 includes a gas meter;

A plurality of gas meters are configured to send the current month gas count data and the gas history count data to the corresponding management sub-platform 300 via a sensor network sub-platform 200 according to their own IDs.

Each management sub-platform 300 is configured to generate a gas using change waveform based on the current month gas count data and gas history count data.

Each management sub-platform 300 is further configured to determine whether the current month gas count data is greater than the preset first threshold and whether the current slope of the gas using change waveform is greater than the preset second threshold.

Herein, the management sub-platform 300 is further configured to automatically adjust the preset first threshold based on different seasons.

If the current month gas count data is greater than the preset first threshold and the current slope of the gas using change waveform is greater than the preset second threshold, the management sub-platform 300 is further configured to determine whether the previous month gas count data is lower than the preset third threshold.

If the previous month gas count data is lower than the preset third threshold, the management sub-platform 300 is further configured to calculate the average value of gas count data that is greater than the preset third threshold within a preset time.

The management sub-platform 300 is further configured to calculate the simulated slope based on the average value of the gas count data and current month gas count data.

If the simulated slope is greater than the preset second threshold, the management sub-platform 300 is further configured to generate an energy-saving prompt.

The management sub-platform 300 is further configured to send the energy-saving prompt and the ID associated with the energy-saving prompt to the service platform 400.

The service platform 400 is configured to send the energy-saving prompt to the corresponding user sub-platform 500 according to the ID associated with the energy-saving prompt.

In addition, the management sub-platform 300 is further configured to arrange the current month gas count data in ascending order based on the IDs, and selects the IDs corresponding to the first N pieces of current month gas count data.

The management sub-platform 300 is further configured to send the rewards information and a plurality of IDs to the service platform 400.

The service platform 400 is further configured to separately send the rewards information to the service platform 400 based on a plurality of IDs.

Herein, the reward information may be an electricity purchase coupon or an electricity purchase discount coupon or environment-friendly user credits.

In conclusion, the gas meter energy-saving prompting method based on the compound IoT and the IoT system provided by the present invention use each management sub-platform to generate a gas using change waveform according to the current month gas count data and the gas history count data, and determine whether the current month gas count data is greater than the preset first threshold and whether the current slope of the gas using change waveform is greater than the preset second threshold; if so, generate an energy-saving prompt. If the current month gas count data is greater than the preset first threshold, it indicates that the user has used gas excessively in the current month. If the slope is small, it indicates that the increase of the gas usage of the user has slowed down or has fallen, the user has a sense of saving, and it is not needed to send an energy-saving prompt temporarily. If the slope is large, it indicates that the increase of the gas usage of the user is fast, an energy-saving prompt needs to be sent, which conforms to the actual situation of the user and sends energy-saving prompts for users who truly do not have environmental awareness.

In several embodiments provided by the present application, it should be understood that the disclosed apparatus and method may also be implemented in other manners. The described apparatus embodiments are merely exemplary. For example, the flowcharts and block diagrams in the drawings illustrate the system architecture, function, and operation of possible implementations of apparatuses, methods, and computer program products according to various embodiments of the present invention. In this regard, each block in the flowcharts or block diagrams may represent a module, program segment, or portion of code, which includes one or more executable instructions for implementing the specified logical function(s). It should also be noted that in some alternative implementation manners, the functions noted in the block may occur out of the sequence noted in the drawings. For example, two continuous blocks, in fact, may be executed concurrently, or in a reverse order, which will depend upon the functions involved. It will also be noted that each block of the block diagrams and/or flowcharts, and combinations of blocks in the block diagrams and/or flowcharts, may be implemented by a special hardware-based IoT system that performs the specified functions or acts, or by using combinations of special hardware and computer instructions.

In addition, each module in the embodiments of the present invention may exist independently, and two or more modules may be integrated into an independent part.

When a function is implemented in the form of the software functional unit and sold or used as a separate product, the function may be stored in a computer readable storage medium. Based on such understanding, the technical solutions of the present invention or the part that makes contributions to the prior art or a part of the technical solutions may be substantially embodied in a form of a software product. The computer software product is stored in a storage medium, and includes several instructions to instruct a computer device (which may be a personal computer, server, network device, or the like) to execute all or some steps of the methods described in the embodiments of the present invention. The foregoing storage medium includes: various media capable of storing a program code, such as a disk, a mobile hard disk, a Read-Only Memory (ROM), a Random Access Memory (RAM), a magnetic disk or an optical disk. It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

The foregoing descriptions are merely specific implementation manners of the present invention, but are not intended to limit a scope of protection of the present invention. Any variation or replacement readily figured out by a person skilled in the art within the technical scope disclosed in the present invention shall fall within the scope of protection of the present invention. Therefore, the scope of protection of the present invention shall be subject to the scope of protection of the claims.

It should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or devices including a series of factors not only include those factors, but also include other factors listed implicitly, or further include inherent factors of the processes, methods, articles or devices. In the absence of more limitations, the factors defined by the statement “include one . . . ” do not exclude other identical factors in the processes, methods, articles or devices including said factors.

What is claimed is:

1. A gas meter energy-saving prompting method based on a compound Internet of Things (IoT), wherein the method is applied to a gas meter energy-saving prompting IoT system based on a compound IoT; the gas meter energy-saving prompting IoT system based on the compound IoT comprises a plurality of user sub-platforms, a service platform, a plurality of management sub-platforms, a sensing network sub-platform, and a plurality of object sub-platforms; each of the object sub-platforms comprises a gas meter; and the gas meter energy-saving prompting method based on the compound IoT comprises:
sending, by the plurality of gas meters, the current month gas count data and the gas history count data to the corresponding management sub-platform via a sensor network sub-platform according to their own IDs.
generating, by each of the management sub-platforms, a gas using change waveform based on the current month gas count data and the gas history count data;
determining, by each of the management sub-platforms, whether the current month gas count data is greater than the preset first threshold and whether the current slope of the gas using change waveform is greater than the preset second threshold;
generating, by the management sub-platform, an energy-saving prompt if the current month gas count data is greater than the preset first threshold and the current slope of the gas using change waveform is greater than the preset second threshold.
sending, by the management sub-platform, the energy-saving prompt and ID associated with the energy-saving prompt to the service platform; and
sending, by the service platform, the energy-saving prompt to the corresponding user sub-platform according to the ID associated with the energy-saving prompt.

2. The gas meter energy-saving prompting method based on the compound IoT according to claim 1, wherein after the step of determining, by each of the management sub-platforms, whether the current month gas count data is greater than the preset first threshold and whether the current slope of the gas using change waveform is greater than the preset second threshold, the gas meter energy-saving prompting method based on the compound IoT further comprises:
determining, by the management sub-platform, whether the previous month gas count data is lower than the preset third threshold;
calculating, by the management sub-platform, if the previous month gas count data is lower than the preset third threshold, the average value of gas count data that is greater than the preset third threshold within a preset time.
calculating, by the management sub-platform, the simulated slope according to the average value of gas count data and current month gas count data; and
generating, by the management sub-platform, an energy-saving prompt if the simulated slope is greater than the preset second threshold.

3. The gas meter energy-saving promoting method based on the compound IoT according to claim 1, wherein the method further comprises:
automatically adjusting, by the management sub-platform, the preset first threshold based on different seasons.

4. The gas meter energy-saving promoting method based on the compound IoT according to claim 1, wherein
the management sub-platform arranges the current month gas count data in ascending order based on the IDs, and selects the IDs corresponding to the first N pieces of current month gas count data;
the management sub-platform sends the rewards information and a plurality of IDs to the service platform; and
the service platform separately sends the rewards information to the service platform based on the plurality of IDs.

5. The gas meter energy-saving prompting method based on the compound IoT according to claim 4, wherein the rewards information is an electricity purchase coupon or an electricity purchase discount coupon or environment-friendly user credits.

6. A gas meter energy-saving promoting IoT system based on a compound IoT, comprising a plurality of user sub-platforms, a service platform, a plurality of management sub-platforms, a sensor network sub-platform, and a plurality of object sub-platforms; each of the object sub-platforms comprises a gas meter;
the plurality of gas meters are configured to send the current month gas count data and the gas history count data to the corresponding management sub-platform via a sensor network sub-platform according to their own IDs;
each of the management sub-platforms is configured to generate a gas using change waveform based on the current month gas count data and the gas history count data;
each of the management sub-platforms is further configured to determine whether the current month gas count data is greater than the preset first threshold and whether the current slope of the gas using change waveform is greater than the preset second threshold;
the management sub-platform is further configured to generate an energy-saving prompt if the current month gas count data is greater than the preset first threshold and the current slope of the gas using change waveform is greater than the preset second threshold;
the management sub-platform is further configured to send the energy-saving prompt and the ID associated with the energy-saving prompt to the service platform; and
the service platform is configured to send the energy-saving prompt to the corresponding user sub-platform according to the ID associated with the energy-saving prompt.

7. The gas meter energy-saving prompting IoT system based on the compound IoT according to claim 6, wherein the management sub-platform is further configured to determine whether the previous month gas count data is lower than the preset third threshold;
if the previous month gas count data is lower than the preset third threshold, the management sub-platform is further configured to calculate the average value of gas count data that is greater than the preset third threshold within a preset time;
the management sub-platform is further configured to calculate the simulated slope according to the average value of gas count data and current month gas count data; and
if the simulated slope is greater than the preset third threshold, the management sub-platform is further configured to generate an energy-saving prompt.

8. The gas meter energy-saving prompting IoT system based on the compound IoT according to claim 6, wherein the management sub-platform is further configured to automatically adjust the preset first threshold based on different seasons.

9. The gas meter energy-saving prompting IoT system based on the compound IoT according to claim 6, wherein
the management sub-platform is further configured to arrange the current month gas count data in ascending order based on the IDs, and select the IDs corresponding to the first N pieces of current month gas count data;
the management sub-platform is further configured to send the rewards information and a plurality of IDs to the service platform; and
the service platform is further configured to separately send the rewards information to the service platform based on the plurality of IDs.

10. The gas meter energy-saving prompting IoT system based on the compound IoT according to claim 9, wherein the rewards information is an electricity purchase coupon or an electricity purchase discount coupon or environment-friendly user credits.
